(19) United States
(12) Patent Application Publication
(10) Pub. No.: US 2006/0271857 A1
(43) Pub. Date: Nov. 30, 2006

(54) Imaging system for network traffic data

(76) Inventors: David Rosenbluth, Fanwood, NJ (US); Marc F. Pucci, Bridgewater, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 11/127,723

(22) Filed: May 12, 2005

(51) Int. Cl. G06F 3/00

(52) U.S. Cl. 715/733

(57) ABSTRACT

Systems and methods are provided for filtering and processing network traffic data and for providing visual representations of the processed data. A lens may identify or filter source and destination addresses in an address space, or identify and filter other network information of interest. A receptor array can be configured to process selected traffic data parameters such as IP header information. The visual representations can be used in real-time network management and to identify anomalous conditions such as distributed denial of service attacks. Image data can be subsequently processed by graphics processors to enhance or identify features in the images. The lens and receptor array can be used alone or together. The receptor array may be configured as a foveated array having regions of different resolution. A saccade controller may also be included for controlling operation of the lens and the receptor array.

### CROSS-REFERENCE TO RELATED APPLICATIONS

This application is related to U.S. patent application Ser. No. 11/______, filed concurrently herewith and entitled “RECEPTOR ARRAY FOR MANAGING NETWORK TRAFFIC DATA,” and to U.S. patent application Ser. No. 11/______, filed concurrently herewith and entitled “LENS-BASED APPARATUS AND METHOD FOR FILTERING NETWORK TRAFFIC DATA,” the disclosures of which are hereby expressly incorporated by reference herein.

### BACKGROUND OF THE INVENTION

The present invention relates generally to systems and methods of processing data for use in computing networks. More particularly, the present invention relates to image-based processing of network traffic data.

Computing networks have been in existence for decades. Such networks include small local area networks (LANs), larger wide area networks (WANs), corporate intranets and the global Internet. Depending upon the size of the network, there may be as few as two computers to as many as millions of computers or more.

FIG. 1 illustrates a network 100 including a first or source computer 102 and a second or destination computer 104 that are connected together by one or more network facilities 106a, 106b or 106c. The network facilities 106a-c may include any number of routers, gateways, servers and/or other devices that form the backbone of the network 100 and pass data across the network. The source computer 102 may connect to one or more of the network facilities 106a-c through link 108a and/or link 108b, which may include a wired connection (e.g., RJ-11 or RJ-45 connectors or a cable modem) or a wireless link (e.g., a wireless LAN card). Similarly, the destination computer 104 may connect to one or more of the network facilities 106a-c through link 110a and/or link 110b, which may also be wired and/or wireless links. The network facilities 106a-c may communicate with one another using links 112a-c. Of course, it should be understood that the network 100 is merely illustrative of one of many different network topologies that can exist in a computing network. Furthermore, it is possible to interconnect networks together to create a network of networks, such as the Internet.

There are many methods of transmitting data across computer networks. For instance, the Internet employs Transmission Control Protocol/Internet Protocol (TCP/IP) to route data between source and destination computers. Information is typically transmitted between the source computer 102 and the destination computer 104 by data packets using TCP/IP. A data packet is a basic data unit that typically includes a header and data following the header. The header typically includes the source address, destination address, and other information necessary to route the data packet across the network. On the Internet, the source address and/or the destination address are typically represented as 32-bit IP addresses. Each IP address is segmented into four octets of eight bits, which are represented in decimal form for ease of use. The decimal form of each octet ranges from 0 to 255. For example, the reference IP address on a computer may be 127.0.0.1.

FIG. 2 illustrates an exemplary IP packet 200. The first portion of the IP packet 200 comprises header information. The first few bits of header information typically represent the version 202 of the IP protocol employed. Following the version 202 are header length 204, type of service 206 and datagram size 208. Following the datagram size 208 is identification information 210, which may be used along with the source address to uniquely identify the packet of data. Flags 212 may be used, for example, to indicate whether routers can fragment the data packet. Routers may use fragment offset 214 when a single large data packet is fragmented into multiple smaller packets for transmission. The time to live (TTL) 216 relates to the number of hops or links through which the data packet may be routed. Protocol 218 represents the type of transport packet used to carry the IP data packet, such as TCP, UDP, ICMP, etc. Next, a header checksum 220 may be included to detect packet errors that may be created during routing across the network 100. Source address 222 and destination address 224 are then provided. The source address 222 indicates the IP address of the original sender of the packet, such as the source computer 102. The destination address 224 indicates the IP address of the recipient of the packet, such as the destination computer 104. One or more options 226 may be included in the IP packet 200. Finally, the second portion of the IP packet 200 comprises data 228, which may be a small amount of information such as a few bits of data, or a large amount of information such as thousands of bytes of data or more. The IP packet 200 may, in turn, be inserted into a TCP packet or other packet type for transmission.

In many cases, gigabytes or terabytes of information may be transmitted across the network 100 each day. The information can include, by way of example only, e-mail communications, instant messages, documents, images, music files and videos, such as streaming multicast video. Some communications may be unwanted broadcast junk advertising. Furthermore, potentially malicious and/or illegal transmissions such as distributed denial of service (DDoS) attacks may also be propagated across the network 100.

Tracking and understanding the flow of network traffic data is a complex problem that often involves estimating the state of the network. Attempts have been made to quantify data propagation across networks using rule-based systems. Such systems can aid in network traffic planning and traffic forecasting in order to ensure that networks have enough capacity and can route packets in a timely fashion. There have also been attempts to perform anomaly detection using rule-based systems, for instance to identify and stop DDoS attacks. However, the sheer quantity of data substantially impairs real-time processing and analysis in existing systems, whether in automated systems or systems under user control.

It is possible to buffer network traffic data for non-real-time processing. However, many computing networks would benefit substantially from real-time system analysis, as this permits network operators to handle congestion and other issues as they arise. In particular, it is desirable to have a real-time system for processing network traffic data. Therefore, a need exists for systems and methods to enable rapid and effective manual or automated processing of network traffic data. It is also desirable for network traffic data processing systems and methods to provide information in a format that is immediately understandable. For instance, users may have difficulty comprehending massive amounts of numerical data without a proper framework, and even automated systems would benefit from data presented in a format that is easy to process. Thus, a need also exists for systems and methods that can perform image-based processing of network traffic data, and can provide visual representations of such information.

### SUMMARY OF THE INVENTION

Aspects of the present invention include provision of one or more tools, including packet receptors, a lens, and a saccade-based attentional system that can be used alone or in any combination to receive, process and analyze network traffic data and related information. These tools may also be used to generate image-based representations that efficiently capture spatio-temporal network structures on a fine scale, which greatly simplifies state estimation problems for tasks such as anomaly detection and related issues.

The tools and the overall system exploit structure present at fine spatial and temporal scales in network traffic data. This helps to reduce the dimensionality and complexity of the network traffic data in subsequent processing. The tools may be selected to filter and process any type or quantity of information pertaining to network traffic data. Different configurations may be provided which are optimized for network anomalies, network degradation, or other conditions of concern.

In accordance with a preferred embodiment of the present invention, an apparatus for processing computer network traffic data is provided. The apparatus comprises an input for receiving a parameter associated with the computer network traffic data, and a receptor array having at least one receptor operatively connected to the input. The receptor generates an output magnitude and an impulse response based upon the received parameter. The receptor array produces a graphical representation associated with the output magnitude and impulse response.

In one alternative, the receptor comprises a plurality of receptors. Selected receptors are configured to map the received parameter based upon different filtering requirements. In this case, the receptor array may be, for instance, a one-dimensional receptor array or in matrix form. Optionally, the receptor array includes a first region and a second region surrounding the first region. Here, the first and second regions generate the graphical representation. The first region provides a higher resolution than the second region. Desirably, the first region comprises a fovea and the second region comprises a peri-fovea. The peri-fovea at least partly surrounds the fovea. A peripheral region at least partly surrounding the peri-fovea. The peri-fovea provides a higher resolution than the peripheral region.

In another alternative, the receptor comprises a plurality of sub-receptors. Each of the sub-receptors is responsive to a predetermined value or range of values of the received parameter. In this case, each sub-receptor preferably generates a basis function and the receptor produces a value representative of a combination of the basis functions from each of the sub-receptors. Alterantively, the parameter is selected from the group consisting of source address, destination address, time-to-live, hop count, and packet size.

In accordance with another embodiment of the present invention, method of processing network traffic data is provided. The method comprises receiving the network traffic data from a computer network; identifying at least one parameter associated with the network traffic data; processing at least a portion of the network traffic data using a receptor array; and generating a graphical representation of the parameter of the network traffic data with the receptor array.

The method may further comprise the steps of defining an address space of the computer network, the address space including at least one source address and at least one destination address; and mapping the graphical representation mapped to the address space. Alternatively, the method may further comprise focusing on a first portion of the graphical representation at a first resolution and focusing on a second portion of the graphical representation at a second resolution different than the first resolution. In this case, the first resolution preferably provides a higher resolution of image details in the graphical representation than the second resolution. Desirably, the first resolution is determined by a first receptor in a fovea of the receptor array and the second resolution is determined by a second receptor in a periphery of the receptor array. The periphery at least partly surrounds the fovea. In yet another alternative, the method further comprises performing image processing on the graphical representation.

In accordance with a further embodiment of the present invention, a computer processing system for processing network traffic data of a computer network is provided. The system comprises an input, a receptor array, and a display interface. The input receives a parameter associated with the computer network traffic data. The receptor array has at least one receptor operatively connected to the input and is adapted to process the parameter and output a visual identifier based upon the received parameter. The receptor array is operable to produce a graphical representation with the visual identifier. The display interface is operable to provide the graphical representation to a display device.

In one alternative, the system further comprises an image processor for performing image processing on the graphical representation. In another alternative, the input comprises a router operable to define an address space. The address space includes at least one source address and at least one destination address. In this case, the graphical representation is mapped to the address space.

In a further alternative, the receptor comprises a plurality of receptors. Here, the receptor array comprises first and second regions. The first region includes at least a first one of the receptors and the second region includes at least a second one of the receptors. The second region at least partly surrounds the first region. The first and second regions generate the graphical representation with the first region providing a higher resolution than the second region. Preferably, at least some of the receptors are programmable to adaptively process one or more different parameters.

In accordance with yet another embodiment of the present invention, an apparatus for processing computer network traffic data is provided. The apparatus comprises an input for receiving the computer network traffic data and a lens operable to filter the input computer network traffic data. The lens filters based upon a predetermined criteria and maps the filtered data to a receptor array for subsequent processing and visual display thereof.

In one alternative, the lens filters the input data based upon an address space including at least one source address and at least one destination address. In this case, the lens is preferably further operable to zoom into or out of the address space in order to focus on a selected portion of the address space.

The lens may comprise an IP lens for filtering the input data based upon header information in an IP packet. In a different example, the lens may comprise an Ethernet lens for filtering the input data based upon header information in an Ethernet packet or Ethernet wrapper.

In another alternative, the visual display is based upon imaging information output from the receptor array. In a further alternative, the filtered data comprises a packet delay and the lens maps the packet delay onto one or more receptors of the receptor array.

In yet another alternative, the predetermined criteria includes a destination address of the input computer network traffic data, the receptor array includes a plurality of receptors, and the lens maps the filtered data to the receptor array by sending selected portions of the filtered data to selected receptors based upon the destination address.

In accordance with yet another embodiment of the present invention, a method of processing computer network traffic data is provided. The method comprises receiving the computer network traffic data; filtering the received computer network traffic data based upon a predetermined criteria; mapping the filtered data to a processor; and processing the filtered data with the processor to identify at least one feature of the computer network traffic data for subsequent visual display by associating a display parameter with a data parameter of the filtered data.

In one alternative, the method further comprises delineating an address space including at least one source address and at least one destination address. In this case, the step of filtering includes filtering the input data based upon the address space. Desirably, this example further comprises zooming into or out of the address space in order to focus on a selected portion of the address space.

Preferably, the processor comprises a receptor array. The predetermined criteria may include a destination address of the input computer network traffic data. The receptor array desirably includes a plurality of receptors. In this case, mapping the filtered data comprises sending selected portions of the filtered data to selected receptors based upon the destination address. The method may alternatively include changing the data parameter so that the receptor array identifies a different feature of the computer network traffic data.

In accordance with another embodiment of the present invention, a computer processing system for processing network traffic data of a computer network is provided. The system comprises an input, a lens and a display interface. The input is for receiving the computer network traffic data. The lens is operable to filter the input network traffic data based upon a predetermined criteria and to output a parameter associated with the network traffic data. The display interface is operable to provide a graphical representation to a display device. The graphical representation is derived from the parameter.

In an alternative, the system further comprises a receptor array having at least one receptor. The receptor is operable to receive the parameter from the lens, to process the parameter, and to output a visual identifier based upon the parameter. The receptor array is operable to produce the graphical representation including the visual identifier. In this case, the lens preferably filters the input data based upon an address space including at least one source address and at least one destination address. Here, the receptor desirably comprises a plurality of receptors. The lens is operable to provide the parameter to selected receptors based upon the predetermined criteria. Optionally, the system further comprises a routing device operable to receive the network traffic data from the computer network and to define the address space. In a further alternative, the lens is preferably adapted to focus on at least a portion of the address space in response to a control signal.

In accordance with a further embodiment of the present invention, a computer processing system for processing network traffic data of a computer network is provided. The system comprises an input, a receptor array, a display interface and a processor. The input receives network information associated with the computer network traffic data. The receptor array has at least one receptor operatively connected to the input that is adapted to process the network information and to output a visual identifier based upon the received network information. The receptor array is operable to produce a graphical representation with the visual identifier. The display interface is operable to provide the graphical representation to a display device. The processor controls operation of the receptor array.

In one alternative, the processor is operable to pan the receptor array in order to change from a first area of interest of the network information to a second area of interest of the network information. In another alternative, the receptor comprises a plurality of receptors and the receptor array comprises first and second regions. The first region includes at least a first receptor and the second region includes at least a second receptor. The second region partly or fully surrounds the first region. The first and second regions generate the graphical representation. The first region provides a higher resolution than the second region. In this case, the receptor array desirably comprises a matrix of the receptors. The first region is substantially centrally located in the matrix. Optionally, the second region includes a plurality of concentric regions at least partly surrounding the first region. Each of the concentric regions has a resolution different from the other concentric regions. In another alternative, the processor is operable to translate the receptor array so that the first region with the higher resolution is moved from a first area of interest to a second area of interest.

In yet another alternative, the system further comprises a lens that is operable to filter the input network information based upon a predetermined criteria and to output a parameter associated with the network traffic data. In one example, the processor is further operable to cause the lens to zoom into or out of a first area of interest. In another example, the receptor comprises a plurality of receptors and the receptor array comprises first and second regions. The first region includes at least a first receptor and the second region includes at least a second receptor. The second region at least partly encloses or is adjacent to the first region. The first and second regions generate the graphical representation, with the first region providing a higher resolution than the second region. The processor is operable to identify a first area of interest in the second region of the receptor array. In this example, the processor is preferably further operable to translate the receptor array so that the first region having the higher resolution pans to the first area of interest and the lens zooms in on the first area of interest.

In accordance with another embodiment of the present invention, a method of processing network traffic data of a computer network is provided. The method comprises receiving network information associated with the computer network traffic data; processing at least a portion of the network information using a receptor array; generating a graphical representation of the portion of the network information with the receptor array; and controlling operation of the receptor array with a processor.

In one alternative, controlling operation of the receptor array includes panning the receptor array from a first area of interest of the network information to a second area of interest of the network information. In another alternative, the method further comprises filtering the network information based upon a predetermined criteria; and outputting a parameter associated with the network traffic data based upon the filtered network data. In this case, the method may further comprises zooming the receptor array into or out of a first area of interest.

In another alternative, the receptor array comprises a first region including at least a first receptor and a second region including at least a second receptor. In this case, the step of generating the graphical representation includes providing a first resolution in the first region and a second resolution in the second region. Here, the first resolution is desirably higher than the second resolution, and the method may further comprise identifying a first area of interest in the second region of the receptor array. In this situation, the method preferably further comprises translating the receptor array so that the first region with the higher resolution pans to the first area of interest in order to achieve a higher viewing resolution on the first area of interest. The method may then further comprise zooming in on the first area of interest.

In accordance with yet another embodiment of the present invention, a storage medium is provided that stores a program for use by a processor. The program causes the processor to receive network information associated with computer network traffic data in a computing network; process at least a portion of the network information using a receptor array; generate a graphical representation of the portion of the network information with the receptor array; and pan the receptor array from a first area of interest to a second area of interest.

In an alternative, the program further causes the processor to filter the network information based upon a predetermined criteria; output a parameter associated with the network traffic data based upon the filtered network data; and change the magnification of the receptor array on the second first area of interest from a first magnification to a second magnification.

### BRIEF DESCRIPTION OF THE DRAWINGS

FIG. 1 illustrates an example of a computer network.

FIG. 2 illustrates an IP data packet.

FIG. 3(a) illustrates a cross-sectional view of a human eye.

FIGS. 3(b)-(d) illustrate charts of image response intensity, light absorption curves, and a projected spectral intensity function based upon the features of the eye in FIG. 3(a).

FIG. 4(a) depicts a network traffic data imaging system that illustrates aspects of the present invention.

FIG. 4(b) illustrates a processing device in accordance with aspects of the present invention.

FIGS. 5(a)-(b) illustrate portions of the imaging system of FIG. 4(a).

FIGS. 6(a)-(b) illustrate charts of data packet information in accordance with aspects of the present invention.

FIGS. 7(a)-(e) illustrate images generated based on a linear receptor array in accordance with aspects of the present invention.

FIG. 8 illustrates a source/destination address space mapped to a receptor array in accordance with aspects of the present invention.

FIGS. 9(a)-(c) illustrate images generated based on receptor arrays in accordance with aspects of the present invention.

FIGS. 10(a)-(e) illustrate a system and resultant images relating to network data that is associated with different components in a computing network in accordance with aspects of the present invention.

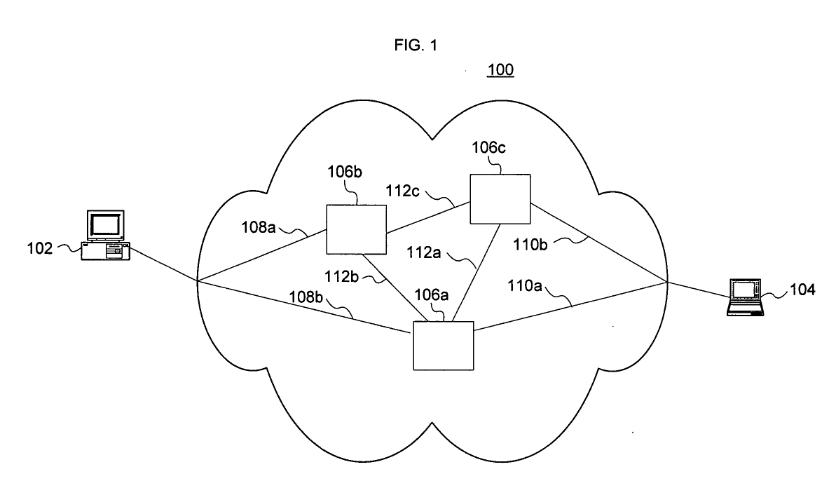

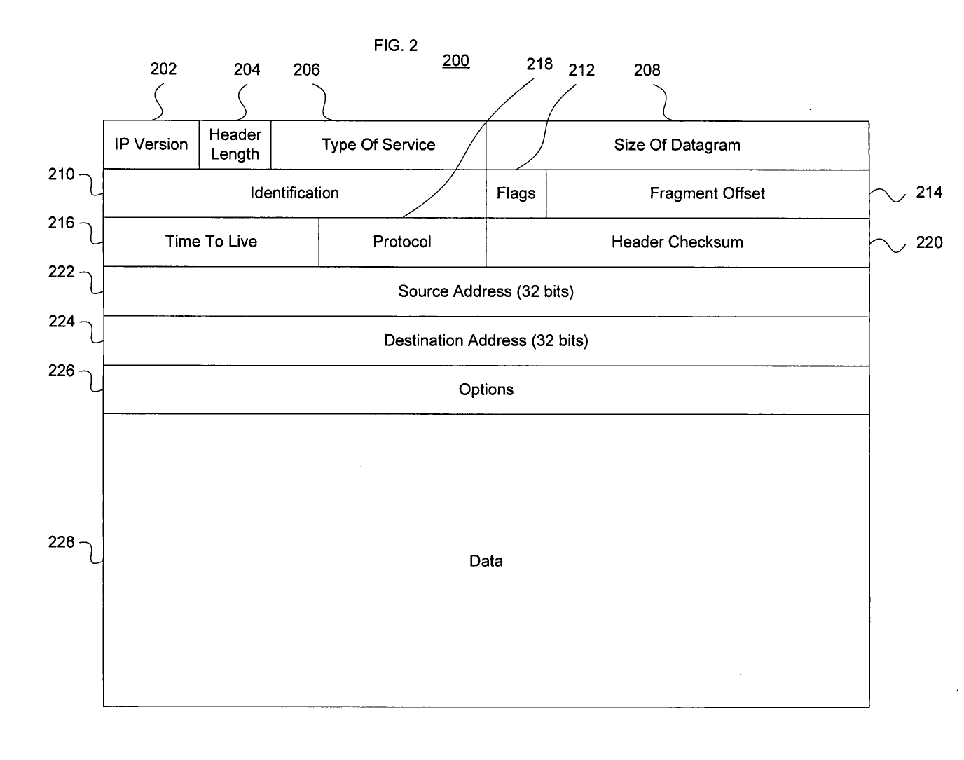

### DETAILED DESCRIPTION

In describing the preferred embodiments of the invention illustrated in the appended drawings, specific terminology will be used for the sake of clarity. However, the invention is not intended to be limited to the specific terms used, and it is to be understood that each specific term includes all technical equivalents that operate in a similar manner to accomplish a similar purpose.

In trying to understand the functionality of a computer network and how information flows across the network, ideally one should understand what types of network elements are in place, where they are positioned, what their resources are, and how the network elements interact. These issues are not simple to address, as there are many different parameters that relate to different features of the network. Furthermore, no two computer networks are exactly alike, as they differ in the number of users, the types and placement of network elements, etc. However, the core purpose of computer networks is to transmit data between computing devices. Thus, it is highly desirable to understand what types of information are being transmitted among computing devices at any given time.

As discussed above, a given computer network may transmit massive quantities of network traffic per day. It is not efficient to dedicate a large quantity of resources to analyze all of the data flowing across a network all the time. In accordance with an aspect of the present invention, it is desirable to reduce the amount of network traffic information so that relevant information may be processed in a meaningful manner. It is also desirable to present relevant information in a manner that is suitable for immediate understanding by users and for real-time automated processing.

Of course, processing data is not new—animals, plants and other living organisms have evolved many different ways handle data using different senses. It is possible to analogize organic data processing in living organisms to the problem of data processing in a computer network. In accordance with the present invention, it has been discovered that methods and systems can be implemented to perform network data processing in manners similar to those performed in selected senses.

By way of example only, the senses of vision, hearing, smell, taste and touch can be used alone or in combination to present a person with information concerning his or her environment. Of these senses, vision is capable of continuously receiving and processing massive amounts of information. The human eye enables a person to identify positions of objects, object movement, interactions between objects, compositions of objects, etc. Light is filtered and received by photoreceptors within the retina, which processes photons of light to generate analog signals that can then be further processed.

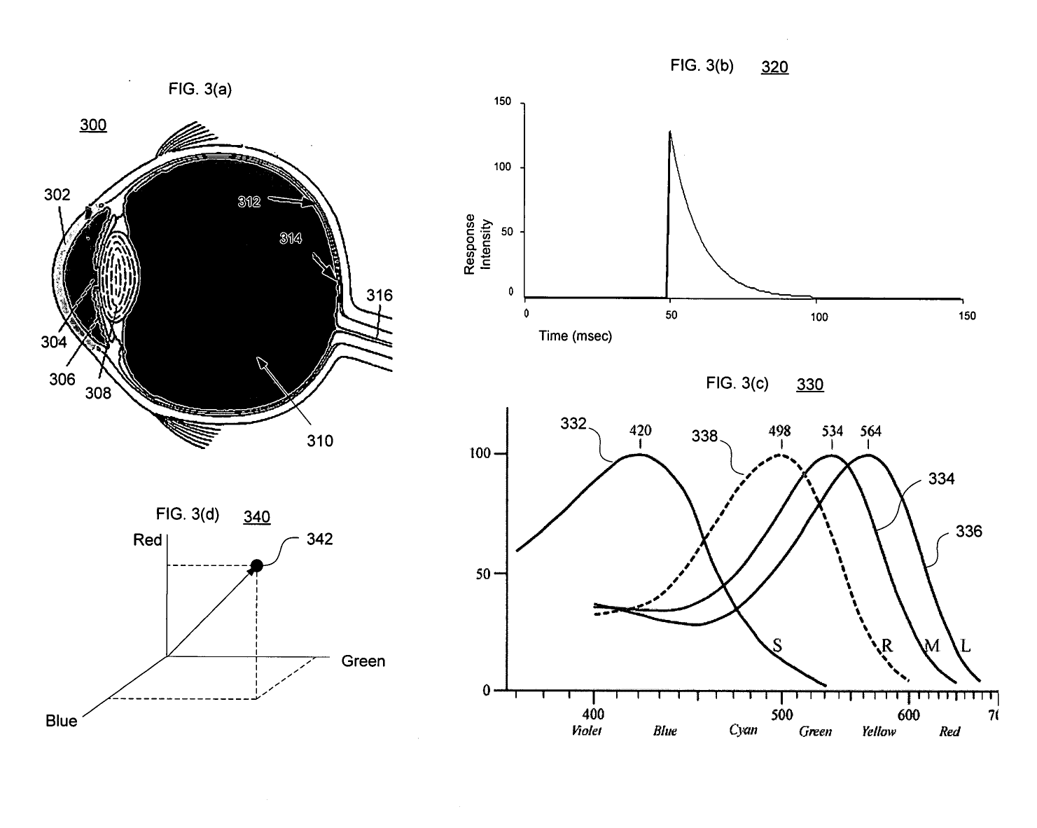

FIG. 3(a) illustrates a cross-sectional view of a human eye 300. As seen in the figure, the eye 300 includes an outer cornea 302 that covers pupil 304 and surrounding iris 306. Behind the pupil 304 and the iris 306 lies a lens 308. Images that pass through the lens 308 are projected through vitreous humor 310 onto the retina 312, which includes fovea 314. As is well known, the retina 312 includes two main types of photoreceptors, rods and cones (not shown). Both cones and rods are present in the fovea 314. The cones are also packed closer together in the fovea 314 than in the rest of the retina 312. The rods are more heavily dispersed along the perimeter of the retina 312 than elsewhere along the retina 312. Rods are most sensitive to light and dark changes, shapes and movement. Cones are less sensitive to light than rods. However, different types of cones are sensitive to different colors, in particular green, red and blue. Signals from a set or “triplet” of green, red and blue cones are used to represent the full spectrum of colors. Signals from the rods and cones are sent to the brain along the optic nerve 316. The brain then translates the signals from the rods and cones into an image, and may then perform subsequent image processing and/or decision-making based upon the received image signals.

The human eye does not pass all visual information to the brain. In fact, the human eye can only process a very small portion of the electromagnetic spectrum, known as the visible spectrum. The lens system at the front of the eye (including the cornea 302, the pupil 304, the iris 306, and the lens 308) focuses light and limits the amount of light which enters the eye. Furthermore, the placement of the rods and cones provides for different kinds of vision. The fovea 314 is the region of the retina 312 that provides for the clearest vision in color. On the other hand, the rod-heavy perimeter of the retina 312 provides good night vision, although with a lower level of clarity than the fovea 314. Additionally, the photoreceptors also perform some degree of data reduction. The photoreceptors are only responsive to certain wavelengths of light. Also, photoreceptors in the human eye do not identify the polarization of received light, which is identified and relied on in some other animals.

While the human eye can detect light with sensitivity close to the theoretical maximum (a single photon/quanta), in practice, daylight vision involves detecting and analyzing a flood of photons. It is of questionable use, and would involve a considerable effort, to distinguish and analyze individual photons. Hence, even for those attributes that are measured by photoreceptors, there is significant data reduction required for processing efficiency and removal of functionally irrelevant information. In photoreceptors there are essentially two important types of data reduction. The first is temporal integration, which filters out information that might be contained in precise timing of photons. The second is the trichromatic representation of wavelength information, which projects the infinite dimensional space of spectral intensity functions to a three dimensional space based on the red, blue and green cones.

The temporal aspects of photoreceptor activity in response to light can be described in terms of its impulse response function specifying the activation of the photoreceptor as a function of time in response to a single photon. This function is well approximated by an exponential decay with a time constant T. FIG. 3(b) illustrates a chart 320 plotting an exemplary response intensity or impulse response function along the Y axis versus time along the X axis for a photoreceptor in response to a photon.

The instantaneous signal impinging on a photoreceptor can be represented as a spectral intensity function representing quantity of light as a function of wavelength. Even when the range of wavelengths and the range of intensities of interest is restricted to a bounded region, as is the case for all animals, the space of spectral intensity functions is of infinite dimension since both intensity and wavelength can assume a continuum of values. Feasible representation of such functions must involve data reduction. In humans, retinal photoreceptors accomplish data reduction by projecting the spectral intensity function onto a three dimensional subspace. One can think of this as an approximation of the spectral intensity function as the sum of three scaled basis functions, which equate to the intensity responses for a triplet of red, blue and green cones. FIG. 3(c) illustrates a chart 330 plotting normalized intensity absorption curves along the Y axis versus wavelength in nanometers along the X axis for a blue cone spectra 332, a green cone spectra 334, a red cone spectra 336, and a rod spectra 338. The coefficient of a basis function in this series is determined by the length of the projection of the spectral intensity function onto the basis function. As seen in the three-dimensional plot 340 of FIG. 3(d), the projected spectral intensity function results in a single resultant color 342 based on the sum of the basis functions. Because the resultant color 342 is derived, or coded, from the red, green and blue impulse responses of a triplet of red, green and blue cones, this process is herein referred to as trichromatic encoding.

Each basis function for the blue, green and red cones is determined by the photo-pigment contained within a given photoreceptor. Different photo-pigments have different response functions describing response as a function of wavelength of light. The number of photo-pigments and the response characteristics of photo-pigments are species specific and are adapted to behaviorally relevant spectra within the particular species' habitat. Hence, the basis functions used in the subspace projection are optimized to both the characteristics of the inputs and the tasks to be performed. As discussed above, humans have three photo-pigments with unimodal response functions. On the basis of the wavelength(s) at which the response functions are maximized, they are referred to as red, green, and blue receptors. Other animals have a greater variety of photo-pigments and can therefore represent and discriminate between a greater numbers of spectra.

Thus, it can be seen that the human eye processes and significantly reduces the amount of image data received prior to transmitting information to the brain. The brain, in turn, uses the received visual information to perform pattern recognition, such as when a baby learns to identify its mother during the first few months of life, as well as making other decisions based upon received images.

The present invention addresses the deficiencies of existing systems by adopting a Bayesian framework for formalizing the network state estimation problem, and applying tools analogous to the organic signal processing systems described above. The framework is applied to the design and implementation of a network imaging system that may be used to provide input to network state estimation algorithms. The system provides programmable or adaptable tools for the estimation of network traffic properties that efficiently represent and process network activity in the form of images. The data reduction achieved with such representations permits the exploration of highly complex traffic attributes that may otherwise go unnoticed.

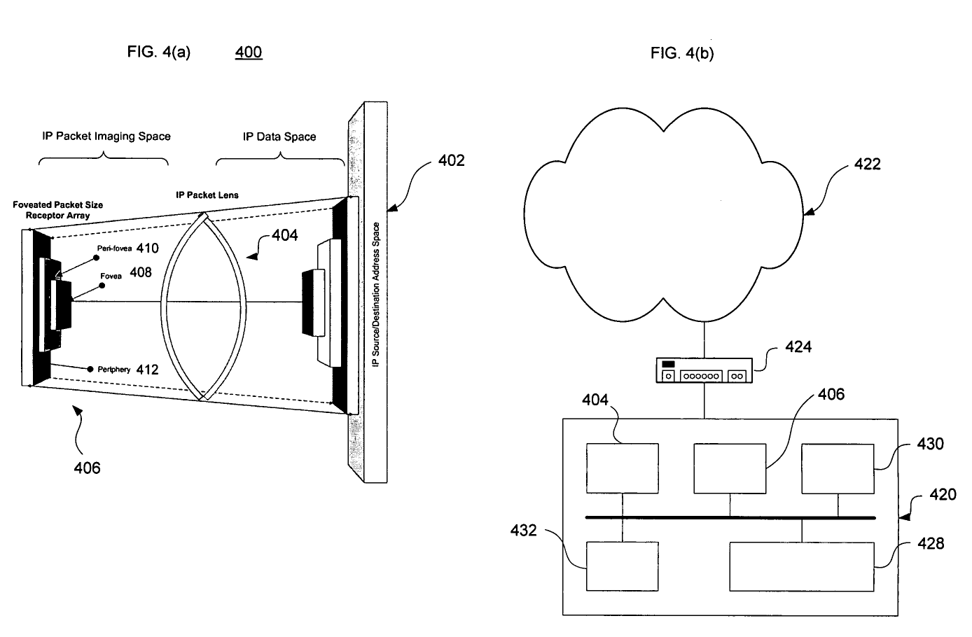

One aspect of the present invention includes an image-based processing system analogous to the human vision system described above. FIG. 4(a) illustrates a preferred embodiment of network traffic data imaging system 400. The imaging system 400 desirably includes a source/destination address space 402, a lens 404 and a receptor array 406. The source/destination address space 402 preferably represents an array of possible source and destination address pairs. The lens 404 filters information transmitted between the source/destination addresses and passes the filtered information to the receptor array 406. In one preferred embodiment, the receptor array 406 includes fovea 408, a peri-fovea 410 surrounding the fovea 408, and periphery 412 surrounding the peri-fovea 410. In another preferred embodiment, the receptor array 406 does not include the fovea 408, the peri-fovea 410 or the periphery 412. This architecture may be referred to as a “non-foveated receptor array.” A non-foveated receptor array 406 may comprise, for instance, a linear array or a simple matrix. Selected information concerning network data is filtered by the lens 404 and processed or identified by the receptor array 406, and is desirably presented in graphical format based upon outputs from the receptor array 406, as will be described below.

The array of the source/destination address space 402 may include anywhere from one pair (a 1×1 array) comprising, for example, a single source computer 102 and a single destination computer 104 up to an array of all possible address pairs (an M×N array) for all source computers 102 and all destination computers 104 in the entire network 100. As shown in FIG. 4(a), the address space 402 may be, for example, an IP source/destination address space. In this case, the lens 404 may be an IP lens, which is capable of filtering data based on, for example, header information in the IP packet. However, the address space 402 may be an Ethernet source/destination address space or other address space. The Ethernet address space typically includes a much smaller range of addresses than the IP address space. In this case, the lens 404 may be an Ethernet lens, which is capable of filtering data based upon, for example, header information in an Ethernet packet or wrapper. Other types of address spaces 402 and lenses 404 can also be employed depending upon the network, the type of transport packet, the information to be analyzed, etc. The address space 402, the lens 404 and/or the receptor array 406 may be implemented in software, hardware, firmware or any combination thereof.

FIG. 4(b) illustrates a functional view of an exemplary processing device 420 connected to a computer network 422. The processing device 420 is adapted to receive network traffic data from the network 422 and to perform functions associated with the imaging system 400. A router or other network device 424 may pass data between the computer network 422 and the processing device 420. For example, the processing device 420 may tap off of a connection at a router 424 or elsewhere in the computer network 422 using “TCPDUMP” or some other routine and make copies of all packets going through that connection. The network data is preferably initially input to the lens 404. As discussed above, the lens 404 filters the network data, preferably based on pre-selected parameters, such as the address space 402 of interest or information received by the receptor array 406.

The lens 404 preferably also focuses the network data. For instance, the lens 404 may identify a set of source/destination address pairs that are of interest, and may direct those selected address pairs onto the fovea 408 of the receptor array 406. Other regions of the network 422 that are of lesser interest may be projected onto the peri-fovea 410 and/or the periphery 412. The lens 404 may also refocus source/destination address pairs from the address space 402 based upon information from the receptor array 406 and/or subsequent image processing as will be discussed below. After the lens 404 performs filtering and/or focusing, data output from the lens 404 may be sent to the receptor array 406 through a bus 426.

When the receptor array 406 processes the filtered data, the resultant data may be stored, for example, as images in a memory 428. An image processor 430 may subsequently process the data. By way of example only, the image processor 430 may perform edge detection or other image processing techniques on stored images, or on real-time information received from the receptor array 406. Processor 432 may control the operation of the lens 404, the receptor array 406, the memory 428 and/or the image processor 430. The processor 432 may be a central processing unit (CPU), application specific integrated circuit (ASIC), digital signal processor (DSP), general-purpose computer or other processing device. As indicated above, the lens 404 and/or the receptor array 406 may be implemented in software, hardware, firmware or any combination thereof. In one alternative, the lens 404 may be omitted or bypassed and the network information may be provided directly to the receptor array 406. In this case, the router 424 may be programmed, hard-wired or otherwise configured to act as a filter by defining the address space 402 for which network traffic will be directed to the receptor array 406. Furthermore, the processing device 420 may comprise a single structure or may comprise a distributed computing system. The memory 428 may comprise any storage medium, and may be integral with or separate from the other components of the processing device 420. In addition, the image processor 430 may comprise, for example, a single general-purpose graphics processor, a multi-processor graphics computer, an ASIC, a DSP, or may be integrated as part of the processor 432. Alternatively, the image processor 430 may be implemented in software or firmware in the processing device 420.

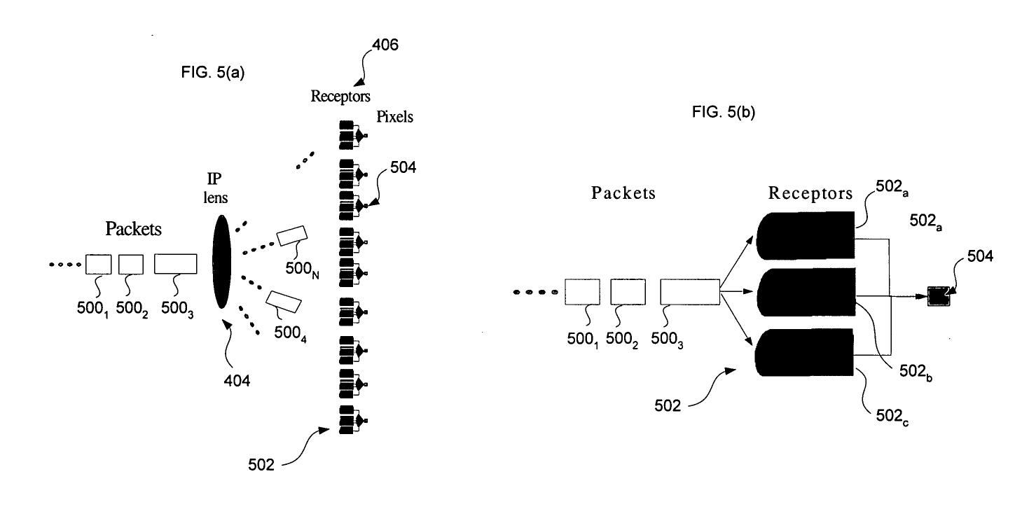

FIG. 5(a) illustrates a portion of the imaging system 400 to show how network traffic in the form of data packets 500₁ . . . 500_{N} are received by the lens 404 and are projected onto or otherwise provided to the receptor array 406 that are part of the processing device 420. The packets 500₁ . . . 500_{N} are preferably received from a network, such as the network 422. By way of example only, one or more routers 424 within the network 422 may provide copies of packets to the processing device 420.

The lens 404 preferably filters the network traffic based upon parameters associated with the data packets 500₁ . . . 500_{N}. Preferably, the lens 404 is implemented in software, although it can also be hard-wired or a combination of both software and hardware. By way of example only, the lens 404 may be software that is configured to filter the data packets 500₁ . . . 500_{N} based on information in the packet headers or in the data itself. Alternatively, the lens 404 may filter the data packets 500₁ . . . 500_{N} based upon information received from one or more of the network facilities within the network 422 concerning network traffic. In a preferred embodiment using the IP packet 200 described above, the source address 222 and the destination address 224 are read from the IP packet 200 and selected information is mapped to appropriate portions of the receptor array 406. The selected information may be any parameter or value in the header or in the data itself, or any other information associated with the network traffic. By way of example only, the lens 404 may perform filtering and/or focusing utilizing a table look-up or based on a range of addresses.

As mentioned above, the receptor array 406 may be implemented using software, hardware, and/or firmware. Preferably, the receptor array 406 is implemented in software. The receptor array 406 may be constructed as a software filter that is programmed or otherwise configured to receive or process packet data or other traffic data, such as network measurement data indicating delay times for sending packets. Thus, the receptor array 406 may be implemented as a multi-dimensional array or group of arrays that may function in parallel and/or in series to process selected network information. By way of example only, the receptor array 406 could be configured to identify the TTL or hop count versus distance between source/destination address pairs of the address space 402.

FIG. 5(b) illustrates a receptor 502 of the receptor array 406. The receptor 502 may be characterized by two parameterized functions, an activation function and an impulse response function. The activation function maps an input signal to an output magnitude. The impulse response function specifies how response decays with time.

The receptor 502 preferably includes multiple sub-receptors such as a triplet of sub-receptors 502a-c. The triplet 502a-c is akin to a photoreceptor triplet of green, red and blue cones in the human eye. As each color cone in the photoreceptor triplet is responsive to a particular wavelength or range of wavelengths, each sub-receptor 502a-c is preferably receptive to a value or a range of values associated with a parameter or value in the packet header, the data, or other information associated with the network traffic. Pixel 504 represents a value (e.g., color, intensity, scale, etc.) derived from a combination of basis functions associated with the sub-receptors 502a-c. In a preferred embodiment, the receptor triplet 502a-c is configured so that each sub-receptor 502a-c is sensitive to packet-length information, which is an analog to wavelength information in photoreceptors. By way of example only, the sub-receptor 502a may be sensitive to small packets (analogous to the shorter wavelengths in reddish light), such as packets having less than 200 bits in length. The sub-receptor 502b may be sensitive to medium size packets (analogous to medium sized wavelengths in greenish light), such as packets having on the order of 200-400 bits in length. The sub-receptor 502c may be sensitive to large packets (analogous to longer wavelengths of bluish light), such as packets having lengths of 400 bits or more.

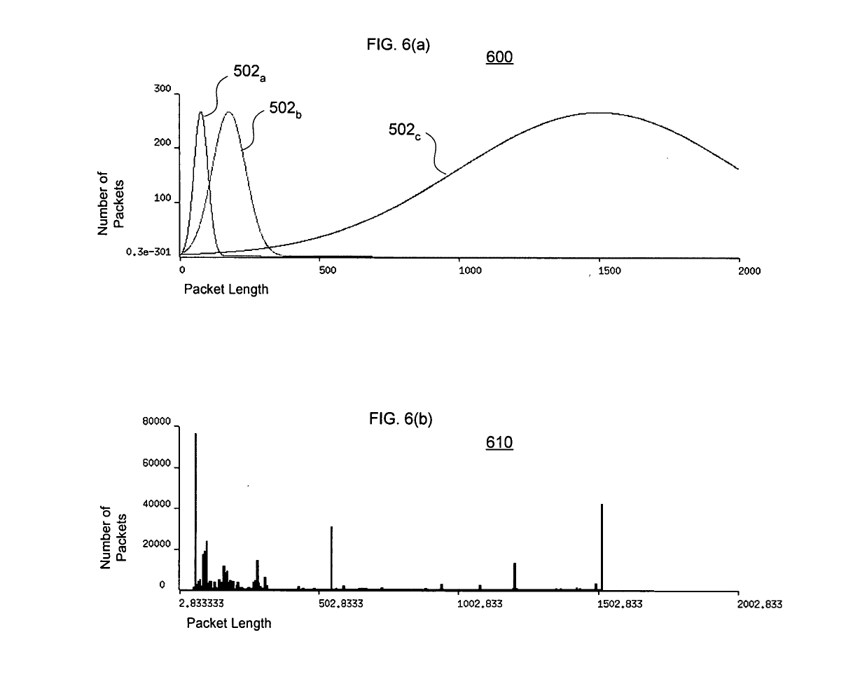

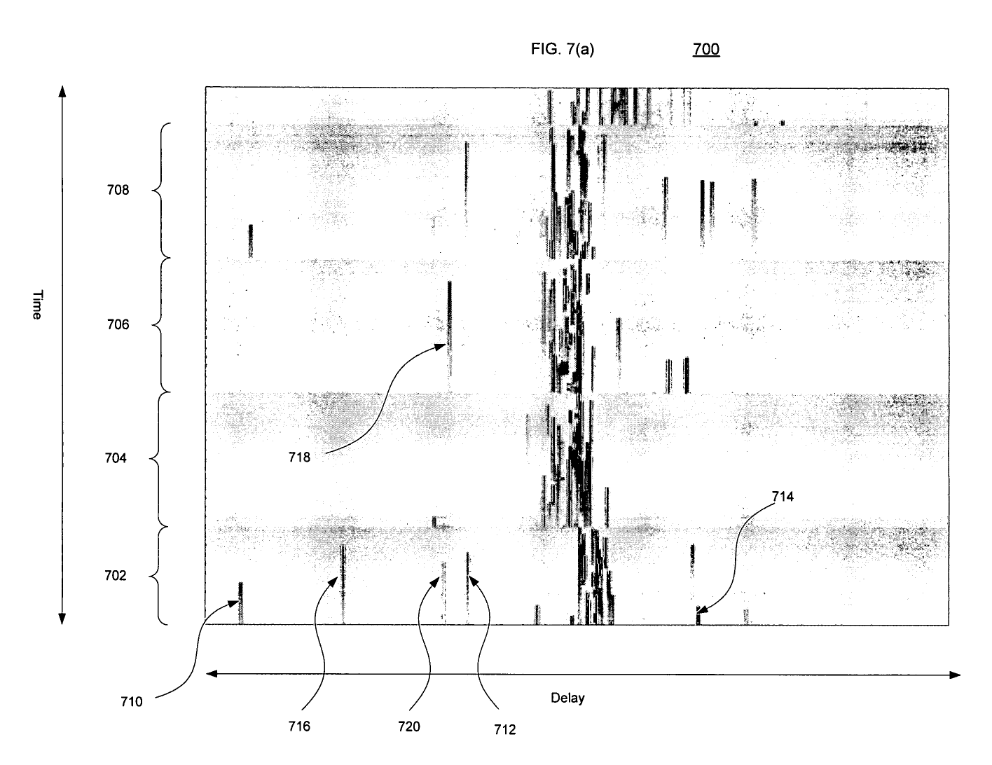

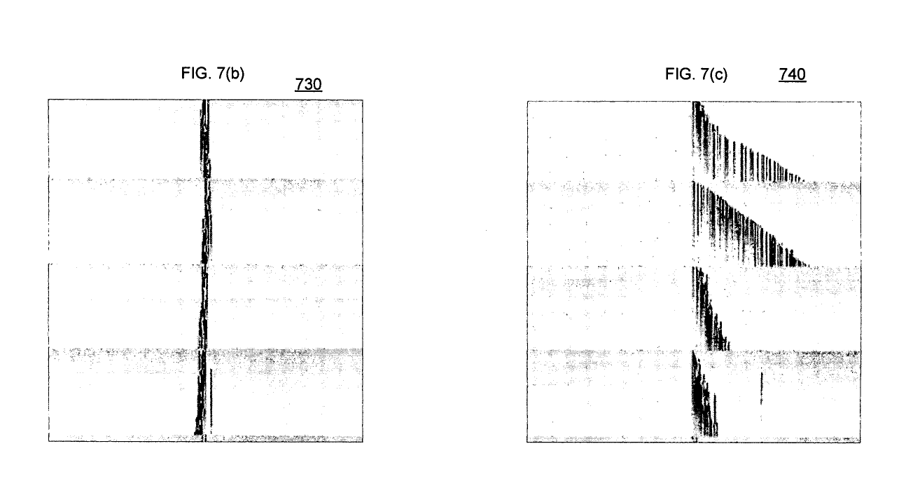

FIG. 6(a) illustrates a chart 600 plotting the number of packets along the Y axis versus packet length along the X axis for small packet receptor 502a, medium size packet receptor 502b, and large size packet receptor 502c. FIG. 6(b) illustrates a histogram 610 plotting the number of packets received along the Y axis versus packet length along the X axis.

It should be understood that any parameter or value in the header or data may be detected by the receptor triplet 502a-c. Alternatively, information about data packets that is not contained within the packets themselves, such as router-generated information relating to delay time or other network measurement data, may also be detectable by the receptors 502. Furthermore, while trichromatic encoding may be performed using the three-receptor triplet 502a-c, it is possible to perform encoding with any number of sub-receptors 502ᵢ of a receptor 502, including a single receptor. In other words, the receptor array 406 preferably comprises an array of receptors 502, each of which may have one or more distinct sub-receptors 502ᵢ therein. The receptor array may be, for example, a linear array or a matrix of receptors 502. Each of the sub-receptors 502ᵢ within the receptor 502 is preferably configured to receive or identify a particular range of values for a predetermined parameter. The ranges of values may overlap among different receptors 502ᵢ within the receptor 502. The number of sub-receptors 502ᵢ that comprise the receptor 502 is preferably selected based on the statistical characteristics of the data to be represented and upon the degree of accuracy that is desired to detect and discriminate between particular network events. In the preferred embodiment of the three-receptor triplet 502a-c, the three basis functions provide a compact visualization of the data that are mapped to different intensities or colors (e.g., red, green, and blue) in an image. The image can be presented on a display, can be subjected to image processing, or both.

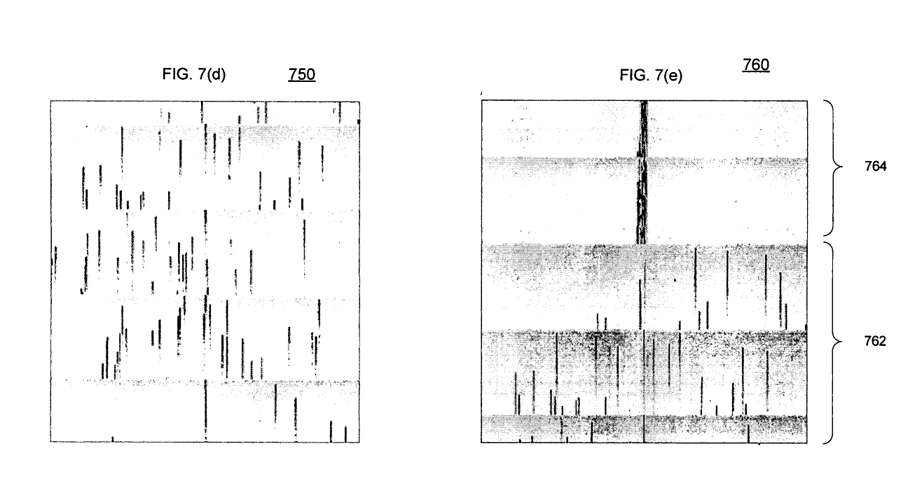

FIG. 7(a) illustrates an image 700 representing the output from a linear receptor array, which illustrates packet delay and jitter. The delay along the X-axis increases from left to right. The Y-axis represents a time increase from the most recent time at the bottom to earlier times toward the top, and is broken into rows 702, 704, 706 and 708, with row 702 being the most recent and row 708 being the oldest. In this example, the lens 404 acts as a delay lens, mapping packet delay to a position along the receptor array.

The receptor array includes a linear set of receptors 502, which each include a three-receptor triplet 502a-c. The linear array of receptors 502 (represented along the X-axis) capture different delays. A short delay is illustrated at point 710, a medium delay is illustrated at point 712 and a long delay is illustrated at point 714. The triplet 502a-c within each receptor measures small, medium and large packet jitter, respectively. A small jitter is illustrated at point 716, a medium jitter is illustrated at point 718 and a large jitter is illustrated at point 720. Preferably, jitter measured by the triplet sub-receptors can be represented using different colors, shading or the like. The delay and jitter information may be collected in many different ways. By way of example only, active monitoring techniques such as packet injection can measure packet transit times between two points in a network. Of course, while jitter and delay are plotted versus time in FIG. 7(a), it should be understood that any parameters or features associated with the network data may be plotted or otherwise graphically illustrated in a single-dimensional or multi-dimensional display.

The linear receptor array can be employed to identify and process different types of network phenomena. For instance, FIG. 7(b) illustrates an image 730 showing a stable output from the linear receptor array. Here, the delay for each of the packets is substantially the same. FIG. 7(c) illustrates an image 740 showing skewed output from the linear receptor array. The skewing of packets may be an anomaly due to how delay is computed in different computers on the network. Skewing can be addressed by re-centering the receptor array, which will be discussed in more detail below.

FIG. 7(d) illustrates an image 750 showing a dispersed output from the linear receptor array. Because the delays are dispersed along the X-axis, it may be necessary to change the data scale and zoom out in the visual representation in order to appropriately capture edge data. Changes in the data scale may be tracked by allowing the field of view of the receptor array to change dynamically, for instance by changing a zoom parameter of the lens 404. FIG. 7(e) illustrates image 760 with dispersed data on bottom half 762 of the image 760 and rescaled data on the top half 764 of the image 760.

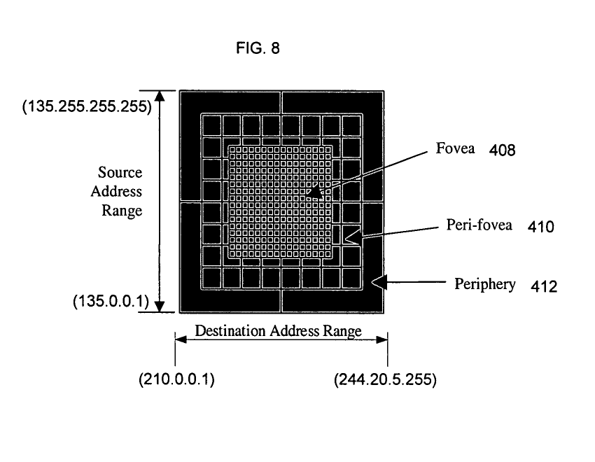

FIG. 8 illustrates the source/destination address space 402 as it is mapped out with relation to the receptor array 406. As shown in the figure, the Y axis may comprise the source address range and the X axis may comprise the destination address range. By way of example only, the source address range is between addresses 135.0.0.1 to 135.255.255.255, and the destination address range is between addresses 210.0.0.1 and 244.20.5.255. While the source address range is along the Y axis and the destination address range is shown along the X axis, there is no reason why the X and Y axes cannot be switched. Furthermore, the address ranges illustrated are merely exemplary, and can be selected based upon the size of the network or a subset of the network undergoing examination.

The fovea 408 provides a central area of high resolution of network traffic data, and preferably includes the densest region of receptors 502. The peri-fovea 410 desirably surrounds the fovea 408 and preferably includes fewer receptors 502 than in the fovea 408. The periphery 412 desirably surrounds the peri-fovea 410 and preferably includes the same or fewer receptors 502 than the peri-fovea 410. Each portion of the receptor array 406, namely the fovea 408, the peri-fovea 410 and the periphery 412, desirably comprises a grid of receptors 502. Each grid segment preferably includes at least one receptor 502. For instance, as shown in FIG. 8, the fovea 408 may include a 16 by 16 grid in which there are 256 receptors 502. The peri-fovea 410 may comprise a coarser grid having, for example, 48 receptors 502. The periphery 412 is shown having the coarsest grid, which may include only four receptors 502.

The range of addresses within the fovea 408 having the greatest quantity of receptors 502 will preferably be analyzed at the highest resolution, while the range of addresses in the periphery 412 will preferably be analyzed at the lowest resolution. For example, because the periphery 412 includes only four receptors 502, data from a large number of source/destination address pairs is preferably averaged or otherwise combined for display or image analysis. Alternatively, some of the data from source/destination address pairs may be discarded or excluded from analysis. While the sub-receptors 502ᵢ may process each received data packet or other segment of information individually, it is also possible for each sub-receptor 502ᵢ to integrate data over time. As see with respect to FIG. 3(b), the impulse response may last 50 milliseconds or more. By way of example only, data from multiple packets may be integrated over a predetermined period of time, such as two milliseconds, ten seconds or five minutes. It is also possible to integrate over the infinite past in an ongoing process. Here, the entire set of results could be weighted or unweighted. For instance, one could perform ongoing weighted processing with more weight preferably given to the most recent data.

It should be understood that the fovea 408, the peri-fovea 410 and the periphery 412 may have any number of receptors 502, including any number of sub-receptors 502ᵢ within each receptor 502. It is possible for the receptors 502 within the fovea 408, the peri-fovea 410 and/or the periphery 412 to have different amounts of sub-receptors 502ᵢ. The quantity of receptors in each region and the number of sub-receptors 502ᵢ therein may depend on various factors, such as desired image resolution, implementation cost, and/or processing time.

Thus, the receptor array 406 and the lens 404 are very flexible, and can be configured depending upon the needs of the operator or of the processing device 420. The receptor array 406 and/or the lens 404 can also perform multiple types of compression. Data from some source/destination address pairs may not be of interest and may be discarded, or may be averaged or otherwise combined with data from other address pairs in the peri-fovea 410 or periphery 412 regions. Data may also be integrated over time and/or over a region of “space” comprising selected address pairs. The space may be representative of a physical geometry of the network, a logical geometry based upon valid IP addresses, etc.

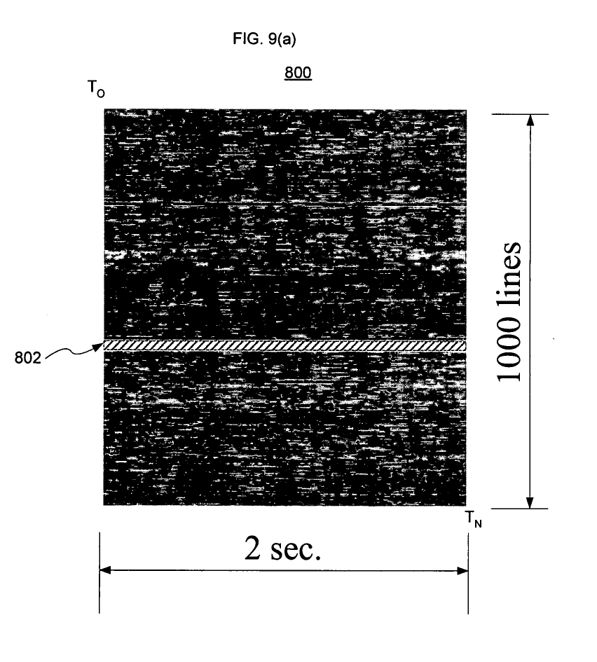

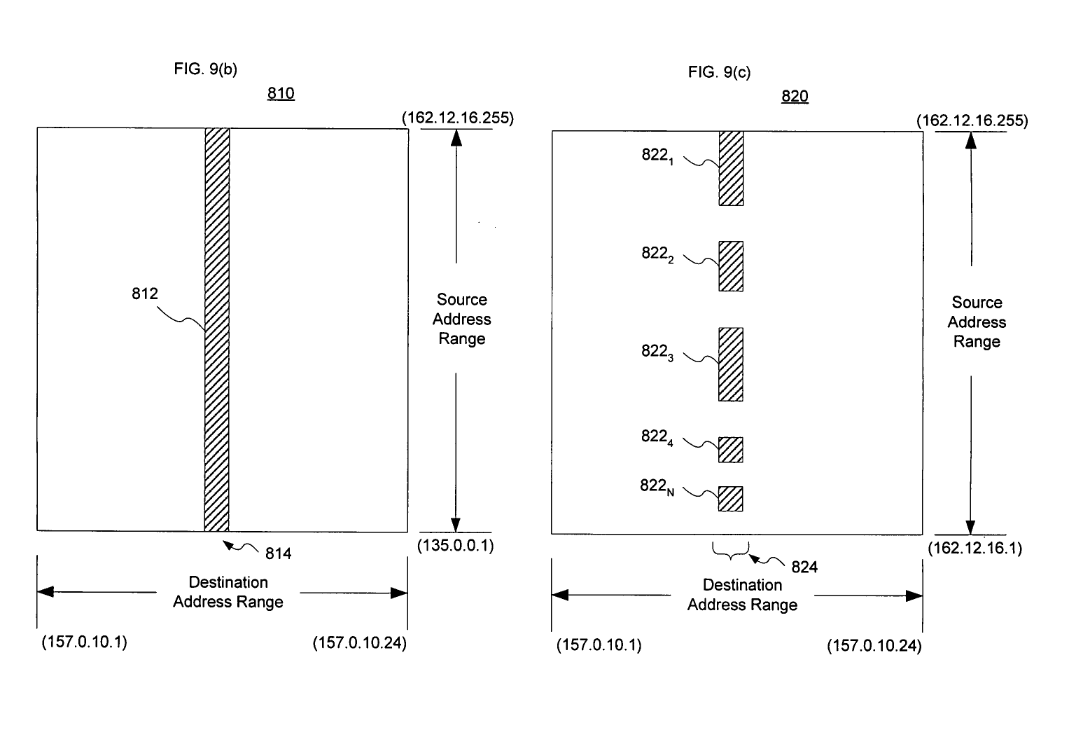

After the receptors 502 in the receptor array 406 receive and process packets or other information from the lens 404 or otherwise receive and process data from the network 422, one or more images are preferably generated based upon the output of the receptors 502. FIG. 9(a) illustrates an image 800 representing the output from a single receptor 502 comprising the triplet 502a-c based upon network data in a test network. In the test network, a primary router and a backup router were connected to network via a gateway. Data was obtained from the network, for instance at the gateway. The single receptor triplet 502a-c acts as a 1×1 receptor array 406. The receptor triplet 502a-c was configured to distinguish between small, medium and large-sized packets as described above. The single receptor triplet 502a-c captured inputs from all source and destination address pairs in the network, therefore no lens 404 was necessary.

The resultant pixels 504 from the receptor triplet 502a-c were used to generate the image 800. The pixels 504 represent the activation of all three sub-receptors 502a-c at a particular point in time. The image 800 represents approximately 30 minutes of packet data, where time is rasterized from left to right and top to bottom so that the top left of the image 800 begins at an initial time To and the bottom right ends at a subsequent time TN. Each line in the image 800 represents approximately two seconds worth of pixels 504 based upon the basis values of the sub-receptors 502a-c.

The image 800 shows distinctive features in the temporal structure of the packet size data. For example, the horizontal band shown as hatched region 802 approximately midway through the image 800 represents traffic from a multicast session. The hatched region 802 is preferably presented on a display with distinctive coloring, shading or similar identifiers based upon the output of the receptor triplet 502a-c. The distinctive band 802 occurs from the use of primarily large packets with a sprinkling of small control packets. In a color display, the band 802 may be illustrated in purple, which would represent the large packets sprinkled with the small control packets. The other pixels 504 in the image 800 vary in color, hue, shading, etc. depending upon the particular information received and processed by the receptor 502.

While it is possible to identify the band 802 visually, either manually or using an automated system, it is also possible to perform subsequent processing on the image 800. By way of example only, edge detection or other well-known image processing techniques may be used to identify the band 802 and/or other features within the image 800. See, e.g., the second edition of “Digital Image Processing” by Rafael C. Gonzalez and Paul Wintz, published by Addison-Wesley, for explanations and examples of different methods of detecting discontinuities in images, the entire contents of which is hereby expressly incorporated by reference. In fact, different types of data flows, different traffic patterns, and/or anomalies may be recognizable based on their features. Feature recognition preferably enables a user or automated system to act on the network traffic data to improve the performance of the network, to combat DDoS attacks, etc.

FIG. 9(b) illustrates an image 810 showing a potential DDoS attack. Activity in region 812 indicates that data is being transmitted from a large number of source addresses to a destination address or addresses 814 within a narrow address range, such as between addresses 157.0.10.1 and 157.0.10.24. Because the information transmitted from the source addresses includes mostly small data packets directed to a single destination address (or small group of addresses) 814, it is reasonable to infer that a DDoS attack is underway, as this is a common method of performing a DDoS attack. Once a likely DDoS attack has been identified, the user or the automated system can use known anti-DDoS techniques for addressing the problem.

By way of example only, if the receptor triplet 502a-c is employed, and if the sub-receptor 502a is the sub-receptor sensitive to small packets, the region 812 is desirably shaded or colored based upon preset characteristics of the sub-receptor 502a, such as red pixels. Thus, in this case, the region 812 may be illustrated as having a reddish hue, indicating many small packets. It should be understood that any other color, hue, shading, and/or visual indicator may also be used for each of the sub-receptors 502ᵢ in a particular receptor 502.

Of course, it is very likely that at least some of the addresses in a given network will not be active or available at any given time. For instance, some IP addresses in a corporate intranet may be reserved for future use or as part of a backup system. In such situations, there will be no traffic flowing from or transmitted to the unused addresses. FIG. 9(c) illustrates an image 820 showing an alternative potential DDoS attack whereby some, but not all, addresses in a source address range are sending small data packets to a destination address or addresses within a narrow address range 824. In this example, there may be multiple regions or bands 822₁ . . . 822_{N} that each may include one or more source machines or computing devices transmitting the DDoS attack to address(s) 824.

Of course, it is possible to translate or move the fovea 408 to a different area of interest. It is also possible to refocus the lens 404 on one or more of the bands 822₁ . . . 822_{N}. Translation and refocusing/zooming are preferably part of a saccade attentional system. The term “saccade” generally refers to small, rapid, jerky eye movements, particularly as the eye moves between two or more points of interest. In accordance with aspects of the present invention, the saccade attentional system controls operations such as panning and zooming that are performed by the lens 404 and a foveated receptor array.

For instance, the lens 404 may pan and/or zoom in so that one of the bands, such as band 822₄, becomes centered and/or magnified within the fovea 408. Alternatively, the lens 404 may zoom out to determine whether more bands 822_{N} exist, or whether additional destination addresses are under attack. In another alternative, activity may be identified within the peri-fovea 410 or within the periphery 412. In these situations, the lens 404 may be refocused so that activity shown using the lower resolution of the peri-fovea 410 and/or the periphery 412 is now shown at higher resolution within the fovea 408. Thus, it should be understood that the resolution of the receptor array 406 is fully configurable.

Generally, it is not necessary to implement saccade control in a non-foveated receptor array, as all regions of the receptor array are treated substantially, if not exactly the same. However, saccade control is highly desirable when using a foveated receptor array. The more segments employed, such as the fovea 408, peri-fovea 410, and periphery 412, the more useful saccade control can be, because the panning and zooming actions allow the user or automated system to achieve complete control over the areas and information to analyze.

Referring back to FIG. 9(c), due to the discontinuous native of the multiple regions or bands 822₁ . . . 822_{N}, it may not be very easy for a human operator to recognize that a DDoS attack is underway, as some or all of the bands 822₁ . . . 822_{N} may be masked or otherwise obfuscated by other pixels 504 in the image 820. Thus, some form of image processing may be desirable to enhance the image 820, for example by filling in the gaps between the bands 822₁ . . . 822_{N}. The gap filling or other image processing may be performed using the image processor 430. By way of example only, the image processor 430 may perform edge detection on the image 820 to enhance the bands 822₁ . . . 822_{N}.

While it is possible to perform edge detection on the image 820, the discontinuities between the regions 822₁ . . . 822_{N} may require additional processing to fill in the gaps or voids. For instance, well-known edge linking and/or boundary detection algorithms may be used. Local analysis may be performed on a small block of pixels in the image 820, which may represent a small neighborhood (e.g., 3×3 or 5×5) of source/destination address pairs. Alternatively, global analysis may be employed using, by way of example only, the Hough transform. The Hough transform process preferably includes computing the gradient of the image 820, identifying subdivisions in a selected plane of the image 820, examining counts of accumulator cells for elevated pixel concentrations, and examining the relationship among pixels within a selected or predetermined region of the image 820.

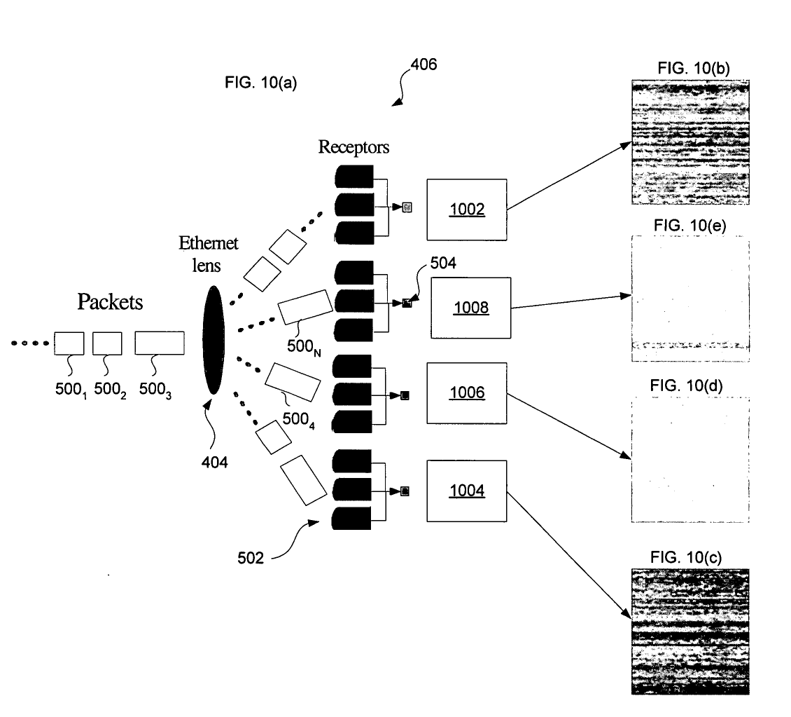

In addition to the numerous examples presented above regarding sorting and analyzing different types of network data, it is also possible to utilize a receptor array to sort network data by destination. FIG. 10(a) illustrates a linear receptor array 406 in the imaging system 400 similar to configuration in FIG. 5(a). Here, the data packets 500₁ . . . 500_{N} are received by the lens 404 and are projected onto or otherwise provided to the receptor array 406 that are part of the processing device 420. The packets 500₁ . . . 500_{N} are preferably received from a network, such as the network 422. The receptors 502 are configured to manage packets destined for specific parts of the network. By way of example only, one or more receptors 502₁ may handle packets for a gateway 1002, one or more receptors 502₂ may handle packets for a first router 1004, one or more receptors 502₃ may handle multicast packets 1006, and one or more receptors 502₄ may handle packets for a second router 1008. Each of the receptors or sets of receptors 502_{N} may include one or more sub-receptors, such as the triplets illustrated in the figure.

FIG. 10(b) illustrates a two-dimensional image illustrating packet data for the gateway 1002. FIG. 10(c) illustrates packet data for the first router 1004. FIG. 10(d) illustrates the multicast packets 1006. Finally, FIG. 10(e) illustrates packet data for the second router 1008. Thus, it can be seen that the present invention enables a user or automated process to view incoming (or outgoing) network traffic at different locations or nodes in the network. This helps to identify areas of elevated activity, bottlenecks, etc. The present invention provides systems and methods including a tool set capable of receiving and operating on network traffic data and related information. Images representative of specific parameters provide immediate feedback as to spatial and temporal conditions of the network. The tools help users and automated systems to sample or reduce massive quantities of traffic data and generate output suitable for subsequent analysis or processing using various techniques such as image processing. Thus, the systems and methods address the network state estimation problem in a unique manner with a revolutionary tool set.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims. By way of example only, while different embodiments described above illustrate specific features, it is within the scope of the present invention to combine or interchange different features among the various embodiments to create other variants. Any of the features in any of the embodiments can be combined or interchanged with any other features in any of the other embodiments described or illustrated herein.

1. A computer processing system for processing network traffic data of a computer network, the system comprising:
an input for receiving network information associated with the computer network traffic data;
a receptor array having at least one receptor operatively connected to the input and adapted to process the network information and to output a visual identifier based upon the received network information, the receptor array being operable to produce a graphical representation with the visual identifier;
a display interface operable to provide the graphical representation to a display device; and
a processor for controlling operation of the receptor array.

2. The system of claim 1, wherein the processor is operable to pan the receptor array in order to change from a first area of interest of the network information to a second area of interest of the network information.

3. The system of claim 1, wherein:
the receptor comprises a plurality of receptors;
the receptor array comprises a first region including at least a first one of the plurality of receptors and a second region including at least a second one of the plurality of receptors, the second region surrounding the first region; and
the first and second regions generating the graphical representation with the first region providing a higher resolution than the second region.

4. The system of claim 3, wherein the receptor array comprises a matrix of the receptors, and the first region is substantially centrally located in the matrix.

5. The system of claim 3, wherein the second region includes a plurality of concentric regions at least partly surrounding the first region, and each of the concentric regions has a resolution different from the other concentric regions.

6. The system of claim 3, wherein the processor is operable to translate the receptor array so that the first region having the higher resolution is moved from a first area of interest to a second area of interest.

7. The system of claim 1, further comprising a lens operable to filter the input network information based upon a predetermined criteria and to output a parameter associated with the network traffic data.

8. The system of claim 7, wherein the processor is further operable to cause the lens to zoom into or out of a first area of interest.

9. The system of claim 7, wherein:
the receptor comprises a plurality of receptors;
the receptor array comprises a first region including at least a first one of the plurality of receptors and a second region including at least a second one of the plurality of receptors, the second region at least partly enclosing the first region;
the first and second regions generate the graphical representation with the first region providing a higher resolution than the second region; and
the processor is operable to identify a first area of interest in the second region of the receptor array.

10. The system of claim 9, wherein the processor is further operable to translate the receptor array so that the first region having the higher resolution pans to the first area of interest and the lens zooms in on the first area of interest.

11. A method of processing network traffic data of a computer network, the method comprising:
receiving network information associated with the computer network traffic data;
processing at least a portion of the network information using a receptor array;
generating a graphical representation of the portion of the network information with the receptor array; and
controlling operation of the receptor array with a processor.

12. The method of claim 11, wherein controlling operation of the receptor array includes panning the receptor array from a first area of interest of the network information to a second area of interest of the network information.

13. The method of claim 11, further comprising:
filtering the network information based upon a predetermined criteria; and
outputting a parameter associated with the network traffic data based upon the filtered network data.

14. The method of claim 13, further comprising zooming the receptor array into or out of a first area of interest.

15. The method of claim 11, wherein:
the receptor array comprises a first region including at least a first receptor and a second region including at least a second receptor; and
the step of generating the graphical representation includes providing a first resolution in the first region and a second resolution in the second region.

16. The method of claim 15, wherein the first resolution is higher than the second resolution, the method further comprising identifying a first area of interest in the second region of the receptor array.

17. The method of claim 16, further comprising translating the receptor array so that the first region having the higher resolution pans to the first area of interest.

18. The method of claim 17, further comprising zooming in on the first area of interest.

19. A storage medium storing a program for use by a processor, the program causing the processor to:
receive network information associated with computer network traffic data in a computing network;
process at least a portion of the network information using a receptor array;
generate a graphical representation of the portion of the network information with the receptor array; and
pan the receptor array from a first area of interest to a second area of interest.

20. The storage medium of claim 19, wherein the program further causes the processor to:
filter the network information based upon a predetermined criteria;
output a parameter associated with the network traffic data based upon the filtered network data; and
change the magnification of the receptor array on the second first area of interest from a first magnification to a second magnification.
